(19) United States
(12) Patent Application Publication
(10) Pub. No.: US 2025/0377300 A1
(43) Pub. Date: Dec. 11, 2025

(54) SYSTEM AND METHOD WITH NEUTRAL DENSITY FILTER STACK TO EXTEND DYNAMIC RANGE OF FLUORESCENCE MEASUREMENTS

(71) Applicant: Advanced Instruments, LLC, Norwood, MA (US)

(72) Inventors: Gail Johnson, Windham, ME (US); Heather Macken, Sebago, ME (US); Jordyn Lawrence, Portland, ME (US)

(73) Assignee: Advanced Instruments, LLC, Norwood, MA (US)

(21) Appl. No.: 18/739,278

(22) Filed: Jun. 10, 2024

(51) Int. Cl. G01N 21/64; G01N 21/27

(52) U.S. Cl. CPC G01N 21/6452; G01N 21/27; G01N 21/6428; G01N 2021/6439; G01N 2021/6471

(57) ABSTRACT

A system and method to extend a dynamic range of fluorescence measurements. The system includes a neutral density filter stack apparatus including a plurality of neutral density filters. The neutral density filter stack modulates the intensity of light from a source. This modulation improves the ability to detect emissions from a wider-range of fluorophore concentrations, specifically addressing inner-filter effects at higher concentrations that would normally require sample dilution. It can be used in a system in which absorbance and fluorescence measurements are carried out, wherein the intensity of the light source is modulated with the apparatus for the fluorescence measurements. In this hybrid system, the stack modulates the intensity of the excitation light source for fluorescence measurements to be made at very low concentrations of analyte. The hybrid system also includes optics for absorbance measurements to be made at concentrations of analyte that are higher than those detected by fluorescence.

### BACKGROUND OF THE INVENTION

### 1. Field of the Invention

The present invention relates to a system and method that extends the dynamic range of fluorescence measurements. More particularly, the present invention includes a Neutral Density Filter Stack (NDFS) that diminishes inner-filter effects of fluorescence that occur at higher concentrations of fluorophores. The system and method can be used with a variety of fluorescence methods and assays. It may also be used in combination with absorbance analysis techniques to extend the analyte measurement range.

### 2. Description of the Prior Art

Accurate measurement of an extended fluorescence detection range is of interest for biopharma, clinical diagnostic, and other life sciences laboratories. Fluorescence spectroscopy has been used to carry out an array of measurements to characterize features of liquid samples. One advantage of using fluorescence is the inherent sensitivity of this method, which results in a much lower limit of detection than can be measured using absorbance spectroscopy (i.e., much lower concentrations of dye can be measured using fluorescence spectroscopy, for example). Another advantage is that fluorescence spectroscopy and fluorescent dyes can provide measurable signals over a very large dynamic range, much larger than absorbance dyes are capable of producing, which results in the need for fewer test solutions (i.e., a standard absorbance dye can cover a dilution range of approximately 1:5 to 1:10, but a fluorescent dye can cover a dilution range of 1:300 to 1:7,000 using one detector gain setting, and a 1:1,000,000 dilution range or higher when using different detector gain settings). In principle this means that one fluorescent dye solution of a given concentration would be needed to measure the same range of dilutions as several absorbance dyes of increasing concentration. A well-known challenge of fluorescence spectroscopy is the differences in fluorescence responses on different readers as well as instability of response (due to instrumental drift) that may be present.

Fluorescence analysis can be used for different purposes including equipment calibration and assay detection. One or more fluorescent dyes in a sample facilitate volume determination used to characterize the calibration of liquid handlers, for example. One or more fluorescent dyes in a sample can also facilitate the assay of the sample. The limits on existing fluorescence measurement systems and methods noted above have limited the use and reliability of fluorescence analysis due to dynamic range limitations. It is of interest to extend the usable dynamic range of fluorescence dye detection and characterization.

One option for extending a dynamic dye detection range for calibration or sample assay involves combining absorbance and fluorescence measurement techniques for sample characterization over volume/concentration ranges not achievable by only one or the other of these two types of measurements. The use of absorbance measurements in combination with fluorescence measurements effectively extends dynamic measurements unavailable with fluorescence analysis alone. However, doing so can make it difficult to account for measurements carried out in an intermediate range. Specifically, reliable measurements are difficult to achieve at the low end of absorbance measurement effectiveness and at the high end of fluorescence measurement effectiveness. In that intermediate range, one can employ mathematical adjustments to interpolate from the high- and low-range measurements. That may be reasonably accurate but less desirable than making actual measurements in the intermediate range. This may be addressed, to an extent, using multiple excitation wavelengths. However, that can add complexity to the equipment and process required and may still not fully account for the entire dynamic range of interest with a minimum number of samples. Alternatively, multiple samples that are different, such as of differing volume, differing analyte concentration, or both can be used to extend the detectable range of a sample with both types of dyes. In the effective absorbance range, some samples of a specimen may approach reliability in the lower end of that absorbance range, while different samples may be effective fluorescence range, and so may approach reliability at the higher end of that fluorescence range.

There remain limitations on extending an entire measurement range using the fluorescence analysis technique. Specifically, at relatively higher fluorescence component concentrations in a liquid sample needed to extend the high end of the measurement range, inner-filter effects render detection difficult and measurements unreliable or unavailable. An inner-filter effect is characterized as the adverse impact on sample observation resulting from the excitation light source illuminating the sample to excess so that analyte detection is difficult. This can be a particular problem with low analyte concentrations in the sample when greater light source excitation power is required to illuminate the analyte. Attempts have been made to address inner-filter effects in fluorescence detection methods; however, such efforts involve adjustments to the detector. Those efforts are of limited reliability and limited value in extending the detectable measurement range as the “washing out” caused by intense illuminations particularly at higher analyte concentrations but not limited thereto.

What is needed is a system and method that extend the effective dynamic measurement range when using fluorescence analysis techniques. What is also needed is such a system and method that enables such range extension while maintaining accuracy and reliability. Further, what is needed is a fluorescence analysis system and method that minimizes the need for multiple samples of differing characteristics to capture reliable measurements over a desired dynamic range. The system and method should be able to provide reliably accurate measurements over a desired dynamic range while minimizing inner-filter effects. The system and method should also be configured for use in combination with advantageous absorbance analysis techniques to establish a broad measurement range with a minimal number of samples to get reliable measurements in a range of interest.

### SUMMARY OF THE INVENTION

It is an object of the present invention to provide a system and method that extend the effective measurement range when using fluorescence analysis techniques. What is also needed is such a system and method that enables such range extension while maintaining accuracy and reliability. It is also an object to provide a fluorescence analysis system and method that minimizes the need for multiple samples to carry out measurements over the desired range. The system and method provide reliably accurate measurements in the desired range while minimizing the impact of inner-filter effects. The system and method may be used in combination with absorbance analysis techniques to establish a broad dynamic measurement range with minimal samples.

These objects of the present invention are realized with a fluorescence analysis system that includes a stack of neutral density filters positioned on the source emitter and used to modulate the intensity of the excitation light source. For purposes of describing the present invention, a “stack” means a plurality of neutral density filters. Unlike the prior art in which a single filter is used, the system of the present invention places the neutral density filter stack between the excitation light source and the sample excited by that light source. In that way, the operator can regulate the light emission intensity as a function of the concentration of the analyte in the sample under measurement. The system is an apparatus including a light source, a neutral density filter stack and a detector. The neutral density filter stack is positioned adjacent to the light source between the light source and a sample under examination. The sample under examination may be contained in a plate reader or a cuvette. The detector is configured to detect emissions from the sample resulting from illumination by the light source excitation as modified by the neutral density filter stack. The method of the invention involves generating a light source excitation, filtering the light source excitation to selectively modulate the light intensity exciting the sample, and detecting emissions from the sample. The light source may be a Xenon flash lamp but not limited thereto. The neutral density filter stack includes a plurality of neutral density filters. Each of the neutral density filters may be of the same or a different optical density or strength, referred to herein as optical density. The neutral density filters may be THORLABS NE510B & NE520B filters but not limited thereto. The detector may be a spectrophotometer such as a Photomultiplier tube (PMT), but not limited thereto. The system may contain more than one light source or more than one detector to accomplish both absorbance and fluorescence on the same system. The system will also contain wavelength selection devices such as filters, monochromators, or both, which are distinct from the neutral density filters described herein.

The system of the present invention enables extended range measurements to be made (lower range, intermediate range, and higher range). There are a variety of potential applications of this technology for assays that use fluorescence measurements as well as those that include a combination of fluorescence and absorbance measurements. These applications include, but are not limited to, calibration of analysis equipment and assays to quantify biomolecules. For example, excitation and emission spectra may be collected using the present invention to characterize assays. That is, the system may be used to quantify and/or characterize a sample. The sample may or may not be a liquid sample. A fluorescence-absorbance hybrid system (FAHS) with neutral density filter stack (NDFS) to modulate the intensity of the excitation light source includes optics for fluorescence measurements to be made at very low concentrations of analyte. The NDFS component of the FAHS is used to extend ranges of detection for fluorescence measurements by lowering the excitation power to reduce inner-filter effects at higher concentrations of analyte. The FAHS also includes optics for absorbance measurements to be made at concentrations of analyte that are higher than those detected by fluorescence. In order to ensure clarity about the invention, it is noted that the physical portion of a fluorescent dye molecule that emits fluorescent light for measurement is commonly referred to as the “fluorophore.” Thus “fluorescent dye” and “fluorophore” are often interchangeably used throughout this disclosure. Similarly for absorbance dyes, the physical portion of an absorbance dye molecule is commonly referred to as the “chromophore.” “Absorbance dye” and “chromophore” are interchangeably used throughout this disclosure.

Combining optics for all three concentration ranges allows for a wide range of analyte concentrations to be detected on a single instrument. The FAHS with NDFS allows the operator to use the same excitation wavelength for directing light from the light source on the sample, and inclusion of the NDF effectively reduces the power of the source directed on the sample, which makes the equipment of the system more amenable to calibration with solid-state plates that are commercially available. The FAHS-NDFS embodiment of the invention can be used for liquid-handling volume verification, serial dilution evaluations, mixing evaluations, and combination assay development (bioreactors, for example), but not limited thereto.

For a liquid delivery device under test, the sample under examination in the FAHS-NDFS embodiment of the invention is a solution that contains a mixture of fluorescence and absorbance dyes. Target volumes of the sample solutions are dispensed into wells of a microtiter plate or into a plurality of cuvettes by the liquid delivery device. Absorbance and fluorescence measurements are collected for each filled container, and these measurements are used to determine the volume of sample solution dispensed by the liquid delivery device. Calibration of the liquid delivery device is accomplished by measuring a volume of a sample solution through a selectable range of volumes dispensed by the liquid delivery device. The sample solution includes one or more chromophores and one or more fluorophores. The one or more chromophores are selected to have absorbance characteristics that do not interfere with the excitation and emission characteristics of the one or more fluorophores. The one or more fluorophores may also be used as a chromophore for absorbance measurements as well as fluorescence measurements.

The method includes selecting a NDFS with a selectable range of desired optical densities and inserting it between the excitation source and the sample, exciting the sample with the light source having an intensity modulated by the selected NDFS configuration, measuring with a spectrophotometer fluorescence of the sample solution to obtain one or more fluorescence measurements, measuring with the spectrophotometer absorbance of the sample solution to obtain one or more absorbance measurements, and, for calibration functionality, calculating a volume dispense size of the dispensed sample solution for each of the one or more wells using the one or more fluorescence measurements and the one or more absorbance measurements. The calculating may be done using only the one or more absorbance measurements or only the one or more fluorescence measurements. Use of the NDFS in the method can minimize or eliminate any one or more additional steps that may otherwise be required to detect dispense volumes through a wide range of concentrations. Those additional steps that may be minimized or eliminated are associated with, but are not limited to, empirically determining fluorescence response constant based on excitation intensity, fluorophore concentration, fluorophore quantum yield, the environment, detector sensitivity, and optical configuration of the plate reader, to generate calibration curves if the fluorescence measurements are not sufficiently linear.

For the FAHS-NDFS version of the invention, the sample solution may be excited with the spectrophotometer at one neutral density setting (low filter, high transmittance stack option) with excitation at one wavelength, then the fluorescence measurements may be carried out with a second neutral density setting (high filter, low transmittance stack option) with excitation at the same wavelength, and the absorbance measurements may be carried out at a second wavelength to cover low, intermediate, and high concentrations. The volume dispense size calculation may be performed over a range of volumes wherein only the absorbance measurements are used to calculate the dispensed volume over a first portion of the range of volumes and only the fluorescence measurements are used over a second portion of the range of volumes. The fluorescence measurements may be carried out with one or more sets of neutral density filters of the stack in place between the source and the sample.

The detector of the system of the invention is selected and configured to measure fluorescence of the one or more fluorophores and, for the FAHS version, to measure absorbance of the one or more chromophores. The system includes a computing device configured to calculate a volume dispense size of the sample solution dispensed using the measured fluorescence and, optionally, the measured absorbance. The system may include one or more of a calibration plate, a plate mixer, and an input device capable of reading and importing measurements from the spectrophotometer. The input device may be a barcode scanner, an RFID scanner or other device. In an embodiment, the spectrophotometer includes an absorbance spectrophotometer and a separate fluorometer.

The system and method of the present invention enables accurate and reliable sample analysis in a broader measurement range than previously possible with fluorescence measurements taken from excitations modulated with one or more sets of neutral density filters of the NDFS. Combining the fluorescence measurements from NDFS usage with absorbance measurements further increases the dynamic range that can be determined.

The invention is described above for various volume measurements, but the same invention can be used to measure concentrations of analytes in fluorescence and absorbance assays when diluting samples is not possible or desirable. For example, the CellTiter-Blue Cell Viability Assay from Promega is a homogeneous, fluorometric assay that uses resazurin indicator dye to measure the metabolic capability of cells. Viable cells can convert non-fluorescent resazurin to its fluorescent product, resorufin. Nonviable cells are unable to reduce resazurin and thus do not display a fluorescent signal. Reduction of resazurin to resorufin also involves a shift of the absorbance maximum from 605 nm to 573 nm, so viability may also be estimated using absorbance. Choosing between absorbance and fluorescence usually depends on both the cell culture density and viability of the cells. For example, at low cell culture density, fluorescence would typically be chosen, especially if the cell culture has low viability, as the fluorescence signal would be very low. At high cell culture density, the end user may be forced to select absorbance because of inner-filter effect. With the present invention however, the end user could still use fluorescence to evaluate cell viability, even for cell cultures with intermediate cell density and intermediate cell viability, which creates a more continuous evaluation of cell viability.

These and other advantages will be further understood upon review of the following detailed description, accompanying drawings, and appended claims.

### BRIEF DESCRIPTION OF THE DRAWINGS

FIG. 1 is a simplified representation of the primary components of the system of the present invention including the neutral density filter stack component and showing light source directing light onto a well of a microtiter plate.

FIG. 2 is a simplified representation of the system of FIG. 1 showing light emitted from the well of the microtiter plate to a spectrophotometer.

FIG. 3 is a graph showing the advantage of NDFS inclusion in fluorescence measurements.

### DETAILED DESCRIPTION OF THE INVENTION

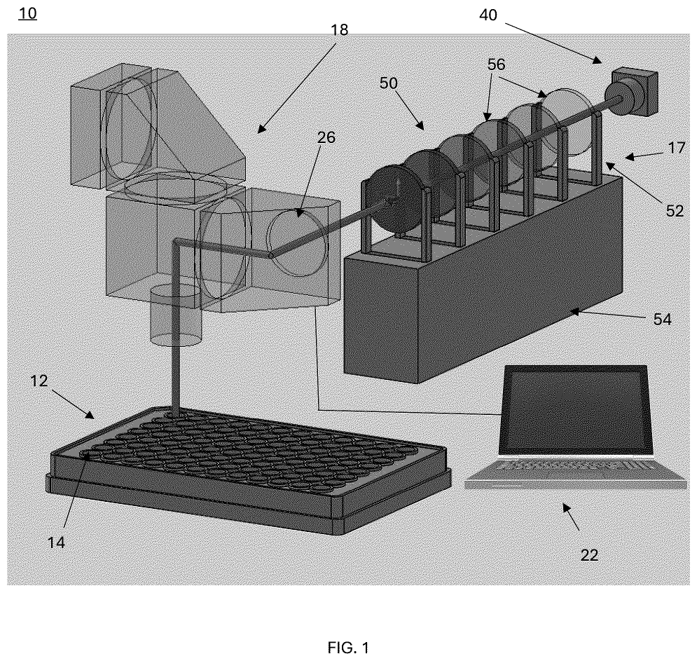

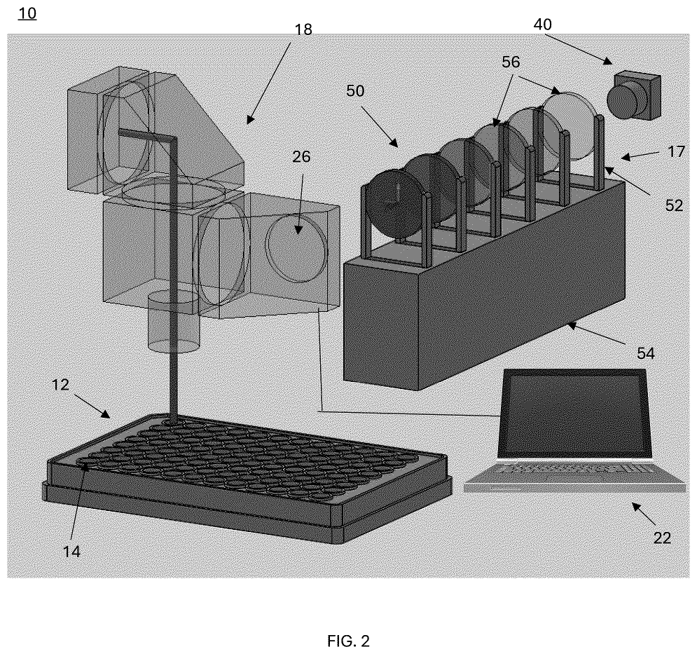

A system 10 of the present invention for measuring sample volumes over a wide range of volumes is represented in FIGS. 1 and 2. The system 10 includes a microtiter plate 12 including a plurality of wells 14 characterized by rows and columns that may be assigned designations. Other well configurations are possible, and the present invention includes the use of cuvettes to carry out an analysis. The system 10 further includes a plate reader 18 capable of generating with a light source 40 a light of selectable wavelength and intensity directed to content of the wells 14. The plate reader 18 is also capable of measuring fluorescence and, optionally, both absorbance and fluorescence. The system 10 also includes a Neutral Density Filter Stack (NDFS) apparatus 17, an optional calibration plate for ensuring accuracy of the plate reader 18, an optional microtiter plate mixer, and a computing device 22. The computing device 22 is programmable to receive information about the microtiter plate 12, the calibration plate 16, and any examined solutions contained in the wells 14. The computing device 22 is programmed to control the plate mixer and the plate reader 18, and to carry out calculations as described herein to determine volumes of fluid dispensed by a liquid dispenser into one or more of the plurality of wells 14.

In general terms, a “plate reader” is a spectrophotometer, and may be a simple device capable of generating light and measuring with one or more detectors fluorescence at fixed wavelengths and, at least in an embodiment of the invention, absorbance at fixed wavelengths. A “plate reader” may also be much more complex and capable of measuring scanned emission spectra for fluorescent samples as accomplished by a scanning fluorometer and, optionally, scanned absorbance spectra over a wide wavelength range as accomplished by a scanning spectrophotometer. For this disclosure, “plate reader” may be used interchangeably for a device capable of generating light and measuring fluorescence signals as well as absorbance signals from a sample as result of being subjected to the generated light.

The solutions contain one or more fluorescent dyes and, for an embodiment of the invention, one or more absorbance dyes. The absorbance/excitation band of the fluorescent dye(s) should not significantly interfere with the absorbance/excitation band of any other fluorescent dye, nor with the absorbance band of any other absorbance dye in the solution in an embodiment of the invention. The emission band of the fluorescent dye(s) should not significantly interfere with the absorbance band of the absorbance dye(s). The absorbance band of the absorbance dye(s) should not significantly interfere with any other absorbance or excitation band.

The microtiter plate 12 has a selectable well density (e.g., 96-well, 384-well, 1536-well, etc.). The microtiter plate 12 may be characterized for dimensional characteristics such as well bottom diameter, side-wall taper angle, well-to-well differences, etc. It may also be characterized for well-to-well variability. Bottoms of the wells 14 may be optically clear or may be opaque. Characteristics about the plate 12 may be reported to the user.

The plate reader 18 may be embodied in a single spectrophotometer capable of generating light and measuring fluorescence signals alone or both absorbance and fluorescence signals from individual wells 14 of the microtiter plate 12. It is noted that absorbance measurements and fluorescence measurements may alternatively be carried out by two separate spectrophotometers, such as with an absorbance spectrophotometer and a fluorometer, or in a single device capable of measuring both absorbance and fluorescence. The calibration plate 16 may optionally be used to control for daily drift inherent to plate readers and allow a method for extending traceability of the spectrophotometer measurements back to a reference spectrophotometer. The optional calibration plate may contain absorbance standards, fluorescent standards, and alignment positioning of the calibration plate, etc. Alignment tests can be accomplished using holes (sometimes circles or ovals) that get smaller and smaller and check that the excitation light and emission light are at the center of the well. There are also additional alignment tests that check for bias at the edges of plates. The NDFS apparatus 17 may be incorporated into such analyses. Characteristics about the calibration plate may be reported to the user.

The optional plate mixer is configured to homogeneously mix the dyes of solutions 26 within the plate wells 14 necessary to perform accurate volume measurements. While the detailed description of the invention refers to solutions, which may be considered to be liquid samples, the invention is not limited to the analysis or characterization of liquid samples. Alternatively, the system 10 may be used to determine adequacy of mixing steps for a customer defined mixing method. The computing device 22 is configured to be capable of being interfaced with the plate reader 18, the mixer and an input device capable of reading and importing all values from the various system components using one or more interface devices. The input device may be a barcode scanner. In the barcode embodiment of the input device, all characteristics of each component will be contained in a barcode label affixed to the component. In this example, the user would use the barcode scanner to read and input this information to the computing device 22. Another type of the input device is an RFID scanner, and the characteristics of each component of the system 10 is carried in an RFID tag affixed to the component.

The computing device 22 is configured to carry out steps of the method to generate output representative of the results of the analysis performed through the invention method described herein. A system software is used to run the computing device 22 and all components. The software is arranged to guide the user through use of all components of the system 10. It incorporates any input information about component characteristics. It uses all input information, and all collected measurements to calculate dispense sample volumes and any other calculation necessary.

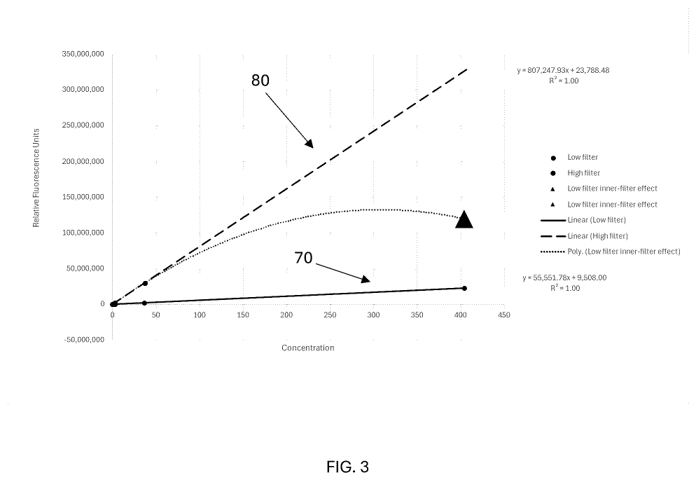

The computing device 22 is configured with respect to the present invention to carry out instructions for performing an evaluation of one or more solutions contained in one or more of the plurality of wells 14. The evaluation includes the step of activating the plate reader 18 to generate an input light signal from the light source 40 as shown in FIG. 1. The computing device 22 is further programmed to receive information from the plate reader 18 in the form of an output light signal and an output fluorescence signal reflected from the solution in the well 14 as represented in FIG. 2. A graph of data obtained from conducting a plurality of measurements, such as the graph shown in FIG. 3, may be used to determine characteristics of the solution in the well and across a plurality of wells 14 including, but not limited to, volume. The computing device 22 may be further programmed to gather information from the reflected signals indicative of the impact of the NDFS apparatus 17 including, for example, the impact of the configuration of the NDFS apparatus 17 on the output signals generated using the plate reader 18.

The NDFS apparatus 17 includes a frame 50 having a plurality of slots 52 and an optional base 54 providing structural support and stability for the frame 50. The frame 50 may or may not be coupled to the plate reader 18. The frame 50 is positioned between the light source 40 and a lens 26 of the plate reader 18. It is to be understood that the light source 40 may be an integral part of the plate reader 18 or it may be a separate component used in conjunction with the measurement functionality of the plate reader 18. The frame 50 may be made of Aluminum or other metallic or nonmetallic material having sufficient structural integrity to keep it fixed in place with respect to the light source 40 during a calibration examination of a liquid dispenser. The NDFS apparatus 17 also includes a plurality of neutral density filters 56. Each filter 56 is sized to fit into individual ones of the slots 52. The filters 56 rest in respective ones of the slots 52. Each filter 56 has a light filtering characteristic ranging from 0.1 to 6.0 optical density. At least two of the plurality of filters 56 may have the same optical density, or all of the filters 56 may have different optical density.

The filters 56 are used to modulate the intensity of the light excitation from the light source 40 before being directed on the solutions 26. The filters 56 are positioned between the light source 40 and the wells 14. It is noted that the light from the light source 40 may be directed vertically or horizontally on the solutions 26. Any one or more of the filters 56 may be removed from or moved within the frame 50 dependent on the concentration of fluorophore in the sample. That is, the number of filters 56 in the light pathway, the locations of the filters 56 in the frame 50, and the optical density of the filters 56 in the frame 50 dictate the intensity of light from the light source 40 reaching the solutions in the wells 14. The user can conduct a fluorescence measurement on the solutions using the detector of the plate reader 18 with a first filter configuration in the frame 50 and then adjust the filter configuration one or more times while carrying out measurements each time and without the need to make any adjustments to the solutions in the wells 14 until a desired volume range of other characteristic of interest has been satisfactorily measured with the plate reader 18. It is to be understood that a wide array of neutral density filters, number of filters 56, is available to the user of the system 10 of the present invention dependent on the solutions under evaluation and characteristics of the solutions to be determined.

FIG. 3 shows the advantage of using the NDFS apparatus 17 in the system 10. Specifically, line 60 shows the extent of linearity of a graph generated with a measurement carried out in a system having no NDFS apparatus 17 between the light source 40 and the solutions. It can be seen that deviation from linearity begins with a fluorophore concentration of about 150 nM. Beyond that concentration, mathematical calculations and/or solution manipulation is required to obtain a linear representation of fluorescence to concentration to account for inner filter effects. On the other hand, line 70 shows the extent of linearity of a graph generated with a measurement carried out in the system 10 with the NDFS apparatus 17 of low filtering, which is about 1% filtering of the light source 40 between the wells 14, while line 80 shows the extent of linearity established using the NDFS apparatus 17 with high filtering, which is about 10% filtering of the light source. As a result, a wide volume range may be measured without any changes to the solutions. This reduces the time required to carry out sample analysis and reduces uncertainties of measurement and measurement equipment complexity.

In a first embodiment of a method of the present invention for determining dispensed liquid volume, an average dispense volume can be calculated using only fluorescence readings of the plate reader 18. While the dynamic range of volume dispensed determination is limited when an unmodulated light source is used to detect emissions of the fluorophore in the sample solution, that dynamic range can be expanded for that same sample solution by filtering the light from the light source using a selectable combination of a plurality of neutral density filters of the NDFS apparatus 17. The solution contains one or more fluorescence dyes that may be one or more of Fluorescein, Fluorescein derivatives, Rhodamine, Rhodamine derivatives, and Quantum dots but not limited thereto. In the first embodiment of the method, the light from the light source is modulated at least once to reduce its intensity.

In the first method, one or more wells are filled with the sample solution using a dispenser under calibration. The method includes the step of transmitting the light from the source to the solution for detection of the one or excited fluorescence dyes without filtering the light. The emissions from the solutions are then analyzed and a calculation of dispensed volume is made in another step. If the dispensation cannot be calculated because the volume dispensed is too low and, as a result, the fluorophore concentration is too high, resulting in inner filter effects, a first neutral density filter set (which may comprise one or more filters 56) of the NDFS apparatus 17 that provide a first filter optical density, is then inserted between the light source and each of the solutions in another step. The emissions from the solutions are then analyzed and a calculation of dispensed volume is attempted. If that calculation is deemed to be determinative of solution dispensed in the wells, no further steps of the method are required. On the other hand, if the calculation is not satisfactory, a second neutral density filter set is inserted between the light source and the solutions in another step. The detection and calculation are then made. The selection and insertion of a selectable neutral density filter set combination may be repeated as often as desired until satisfactory dispensed volume determination is accomplished. This method may be repeated for multiple dispensations into the wells of a plate or into cuvettes. This first embodiment of the method of the invention enables expansion of the dynamic volume range determined without making any modifications to the solutions.

In a second embodiment of the method of the invention for a hybrid absorbance-fluorescence volume determination, one or more absorbent dyes and one or more fluorescent dyes are added to solutions dispensed by a dispenser under calibration. The one or more absorbance dyes may be selected from Rhodamine 110, Fluorescein, Tartrazine, Ponceau S, and copper chloride, but not limited thereto. In a step of the method, absorbance and fluorescence measurements are carried out to determine dispensed volume over a dynamic volume range that is even wider than possible using the first embodiment of the method. In this embodiment, the fluorescence measurement includes the detection of one or more emissions generated using a light source that is modulated with a selectable neutral density filter set.

A step of the method is to excite the solutions of dispensed solutions with light from the light source without filtering and carry out absorbance readings. A next step of the second embodiment of the method is to carry out fluorescence readings on the same solutions. That step may be repeated one or more times with the optical density of the inserted neutral density filter set changed each time. The absorbance readings and the fluorescence readings may then be used to calculate dispensed volume. This method may be repeated for multiple dispensations into the wells of a plate or into cuvettes. This second embodiment of the method of the invention for hybrid dispensed volume determinations enables expansion of the dynamic volume range beyond that possible by absorbance or fluorescence measurements alone without making any modifications to the solutions.

While the present invention has been described with respect to specific examples, it is not intended to be limited to such specific examples. Instead, the present invention is defined by the following claims and reasonable equivalents.

What is claimed is:

1. A system for carrying out fluorescence measurements on a sample over a dynamic range, the system comprising:
a light source arranged to transmit an excitation light to a container including the sample;
a neutral density filter stack apparatus positioned between the light source and the container, wherein the neutral density stack apparatus includes a plurality of neutral density filters;
a spectrophotometer arranged to measure fluorescence of one or more fluorophores in the sample in the container; and
a computing device configured to characterize the liquid sample over the dynamic range using the measured fluorescence.

2. The system of claim 1, wherein the neutral density filter stack apparatus is coupled to the light source.

3. The system of claim 1, wherein the neutral density filter stack apparatus includes a frame and a plurality of slots for removably receiving therein the plurality of neutral density filters.

4. The system of claim 1, wherein each of the plurality of neutral density filters has the same optical density.

5. The system of claim 1, wherein each of the plurality of neutral density filters has a different optical density.

6. The system of claim 1, wherein an order of the plurality of neutral density filters is selectable.

7. The system of claim 1, wherein the spectrophotometer is a plurality of spectrophotometers.

8. The system of claim 1, wherein the computing device is programmed to control positioning of the plurality of neutral density filters between the light source and the container.

9. The system of claim 1, wherein the computing device is programmed to select which of the plurality of neutral density filters are positioned between the light source and the container.

10. The system of claim 1, further comprising an input device capable of reading and importing measurements from the spectrophotometer.

11. A system for carrying out absorbance and fluorescence measurements on a liquid sample over a dynamic range, the system comprising:
a light source arranged to transmit an excitation light to a container including the liquid sample;
a neutral density filter stack apparatus positioned between the light source and the container, wherein the neutral density stack apparatus includes a plurality of neutral density filters;
a spectrophotometer arranged to measure absorbance of one or more chromophores and fluorescence of one or more fluorophores in the liquid sample; and
a computing device configured to characterize the liquid sample over the dynamic range using the measured absorbance and measured fluorescence.

12. The system of claim 11, wherein the neutral density filter stack apparatus is coupled to the light source.

13. The system of claim 11, wherein the neutral density filter apparatus includes a frame and a plurality of slots for removably receiving therein the plurality of neutral density filters.

14. The system of claim 11, wherein each of the plurality of neutral density filters has the same optical density.

15. The system of claim 11, wherein each of the plurality of neutral density filters has a different optical density.

16. The system of claim 11, wherein an order of the plurality of neutral density filters is selectable.

17. The system of claim 11, wherein the spectrophotometer is a plurality of spectrophotometers.

18. The system of claim 11, wherein the spectrophotometer includes an absorbance spectrophotometer and a separate fluorometer.

19. The system of claim 11, wherein the computing device is programmed to control positioning of the plurality of neutral density filters between the light source and the container.

20. The system of claim 11, wherein the computing device is programmed to select which of the plurality of neutral density filters are positioned between the light source and the container.

21. The system of claim 11, further comprising an input device capable of reading and importing measurements from the spectrophotometer.

22. A neutral density filter stack apparatus for modulating an intensity of a light source used in characterizing a liquid sample over a selectable dynamic measurement range, the neutral density filter stack apparatus comprising:
a frame;
a plurality of slots of the frame; and
a plurality of neutral density filters insertable into the plurality of slots of the frame,
wherein the frame is positionable between a light source arranged to transmit an excitation light to the liquid sample and a container including the liquid sample.

23. The apparatus of claim 21, wherein the frame is coupled to the light source.

24. The system of claim 21, wherein each of the plurality of neutral density filters has the same optical density.

25. The apparatus of claim 21, wherein each of the plurality of neutral density filters has a different optical density.

26. The apparatus of claim 21, wherein an order of the plurality of neutral density filters is selectable.

27. A method for carrying out fluorescence measurements on a liquid sample over a selectable dynamic range, the method comprising the steps of:
dispensing the liquid sample into a container, wherein the liquid sample includes one or more fluorophores;
inserting a neutral density filter stack between a light source and the container, wherein the neutral density filter stack includes a plurality of neutral density filters;
exciting the liquid sample with the light source, wherein an intensity of the light source is modulated by the neutral density filter stack;
measuring with a spectrophotometer fluorescence of the liquid sample in the container to obtain a plurality of fluorescence measurements over a selectable dynamic range; and
determining one or more characteristics of the liquid sample using the plurality of fluorescence measurements.

28. The method of claim 27, wherein an excitation band used to elicit one or more emissions of the one or more fluorophores is selected based on operational characteristics of the spectrophotometer.

29. A method for carrying out absorbance and fluorescence measurements on a liquid sample over a selectable dynamic range, the method comprising the steps of:
dispensing the liquid sample into a container, wherein the liquid sample includes one or more chromophores and one or more fluorophores;
inserting a neutral density filter stack between a light source and the container, wherein the neutral density filter stack includes a plurality of neutral density filters;
exciting the sample solution with the light source, wherein an intensity of the light source is modulated by the neutral density filter stack;
measuring with a spectrophotometer absorbance and fluorescence of the liquid sample in the container over the selectable dynamic range to obtain a plurality of absorbance measurements and a plurality of fluorescence measurements; and
determining one or more characteristics of the liquid sample over the selectable dynamic range using the plurality of absorbance measurements and the plurality of measurements.

30. The method of claim 29, wherein the step of determining includes using multiple spectral features of either or both of the fluorescence measurements and the absorbance measurements.

31. The method of claim 29, wherein the one or more chromophores are selected to have absorbance characteristics substantially distinct from excitation and emission characteristics of the one or more fluorophores.

32. The method of claim 29, wherein an excitation band used to elicit one or more emissions of the one or more fluorophores is selected based on operational characteristics of the spectrophotometer.

33. The method of claim 29, wherein the spectrophotometer may be a plurality of spectrophotometers.

34. The method of claim 29, wherein the liquid sample in the container may be excited with the spectrophotometer at a first wavelength, the absorbance measurements may be carried out at a second wavelength, and the fluorescence measurements may be carried out at a third wavelength.

35. The method of claim 29, wherein the one or more chromophores include two or more chromophore concentrations.
